(19) United States
(12) Patent Application Publication
(10) Pub. No.: US 2005/0173818 A1
(43) Pub. Date: Aug. 11, 2005

(54) Method and apparatus for casting a hollow-core concrete product

(76) Inventors: Aimo Seppanen, Saaksmaki (FI); Lassi Jarvinen, Valkeakoski (FI)

Correspondence Address: BURNS DOANE SWECKER & MATHIS L L P, POST OFFICE BOX 1404, ALEXANDRIA, VA, 22313-1404, US

(21) Appl. No.: 10/513,913

(22) PCT Filed: Jun. 4, 2003
(86) PCT No.: PCT/FI03/00440

(30) Foreign Application Priority Data
Jun. 7, 2002 (FI) 20021092

(51) Int. Cl. B29C 39/00

(52) U.S. Cl. 264/33; 425/207; 425/209

(57) ABSTRACT

A method and apparatus are disclosed for casting prestressed hollow-core concrete products, in which method concrete mix is fed onto a casting bed with the help of feeder augers having a diameter smaller than the height of the hollow-core cavities being formed. The invention is characterized by having the concrete mix flowed along slanted leading-end surfaces of the core-forming mandrels so as to form cavities larger than the cross section of the feeder augers.

The invention relates to a method for casting prestressed hollow-core concrete products by a continuous extrusion technique, wherein concrete mix is extruded onto a casting bed with the help of auger feeders having a flight diameter smaller than the height of the hollow-core cavities of the product.

The invention also relates to an extruder-type casting apparatus for manufacturing prestressed hollow-core concrete products, the apparatus comprising a slip-form casting machine adapted movable along a casting bed and incorporating a casting mold formed by side troweling beams and a top troweling beam, the feeder augers of the apparatus being connected to drive machinery and each one of them having adapted as an extension thereof a core-forming mandrel that is aligned substantially concentrically with the center axis of the feeder auger and has a height larger than the largest diameter of the feeder auger.

In slip-form casting, the concrete mix is extruded with the help of the feeder augers into a mold or through nozzles, whereby the casting machine is propelled by the reaction forces imparted by the auger feeders. The ready-cast product is left resting on the casting bed. The hollow-core cavities to be made in the concrete product are formed by mandrels of desired external shape over which the concrete is extruded.

When a hollow-core slab with a height of the hollow-core cavity larger than the maximum diameter of the feeder auger flight is being produced, conventional extruder-type casting machines generally have the core-forming mandrel mounted at the trailing end of the feeder auger asymmetrically in regard to the center line of the feeder auger so that the lower edge of the mandrel is substantially at the same level with the lowest point of the feed auger flight, whereby the upper edge of the mandrel is substantially above the highest point of the feeder auger flight. A flaringly slanted surface is adapted to the leading end of the mandrel at the portion of the mandrel that receives the concrete mix flowing onto the mandrel. This kind of a construction is described in patent publication EP 80333.

A problem associated with this type of asymmetrically mounted mandrel is the heavy wear of the upward slanted portion of the mandrel necessitating a replacement of the mandrel even when other surfaces of the mandrel still could be in a working condition. Moreover, also the feeder augers are worn at a higher rate the higher the concrete mix must be extruded.

The present invention is characterized in that the core-shaping mandrel is mounted substantially concentric with the center line of the feeder auger so that the core-shaping mandrel having a diameter larger than that of the feeder auger flight is designed to flare by a substantially equal angle both upward and downward. However, the slanting angles of both the flaring upper surface and lower surface of the mandrel may be different from each other. The width of the mandrel-however remains essentially the same as the maximum diameter of the feeder auger flight.

More specifically, the method according to the invention is characterized by what is stated in the characterizing part of claim 1 and the apparatus according to the invention is characterized by what is stated in the characterizing part of claim 2.

The method and apparatus according to the invention offers the following significant benefits:
wear of feeder augers is reduced inasmuch as the extrusion height of concrete mix is decreased from that necessary in prior-art constructions,
power consumption of the casting machine is reduced due to the smaller extrusion height,
wear of the core-shaping mandrel occurs in a more equalized fashion than in prior-art constructions, in which aggressive wear attacks the upward slanted portion of the mandrel,
the top troweling beam can have a more advantageous shape, whereby its manufacturing costs are reduced,
a lower cross section of solid concrete for the upper pretensioning strands can be reserved in thick slabs,
in hollow-core slabs of a high cross section the feeder auger can be moved closer to the upper pretensioning strands, whereby the bonding of the strands with the concrete is enhanced due to the more intensive extrusion pressure and compacting action imposed by the feeder auger, and
extruded hollow-core slabs with a larger number of hollow-core cavities in relation to the slab height over the number of cavities conventionally used in prior-art slabs can be manufactured inasmuch as the larger cross-sectional portion of vertical webs in the slab respectively increases the shear strength of the slab.

Next, the invention will be examined in greater detail by making reference to the attached drawing, wherein

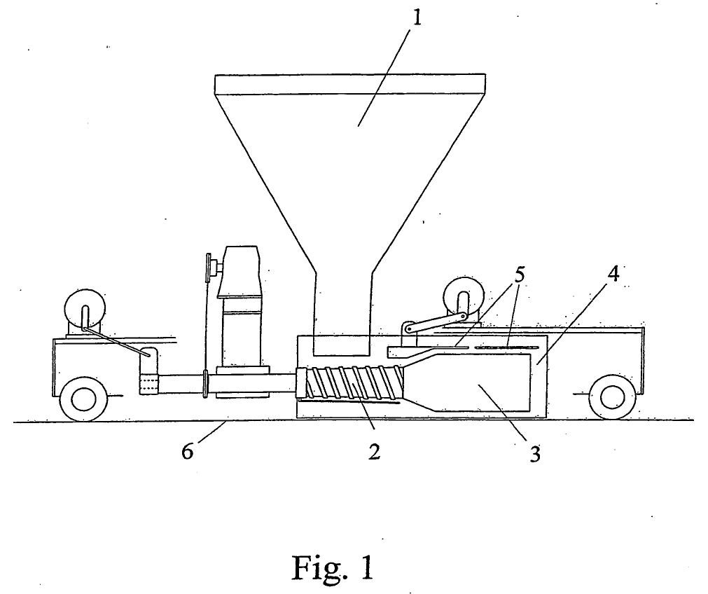

FIG. 1 shows a schematic elevation view of an extruder-type casting apparatus according to the invention;

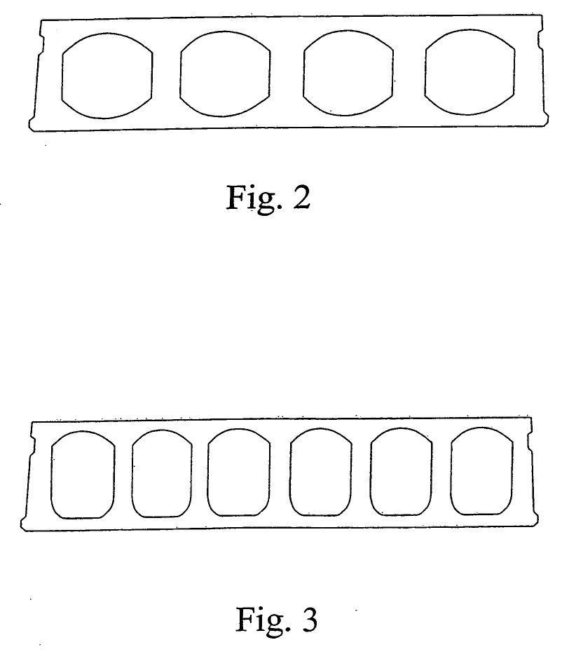

FIG. 2 shows a cross-sectional elevation view of a conventional hollow-core slab; and

FIG. 3 shows a cross-sectional elevation view of a hollow-core slab manufactured using the method and apparatus according to the invention.

Referring to FIG. 1, in the extruder-type casting apparatus shown therein, the major components are a feeder hopper 1, an auger feeder 2, a core-forming mandrel 3, side troweling beams 4 and a top troweling beam 5.

During the operation of the casting apparatus, the concrete mix flows from the feeder hopper 1 onto the feeder augers 2 that extrude the concrete mix into a mold formed by a casting bed 6, side troweling beams 4 and a top troweling beam 5. The core-shaping mandrel 3 is mounted at the trailing end of the feeder auger. The mandrel is adapted concentrically with the center axis of the feeder auger.

As shown in the diagram, the concrete mix being cast is flowed along the slanted surfaces of the leading end of the core-forming mandrel 3 to the upper and lower portions of the cross section of the hollow-core slab being cast. This casting technique makes it possible to fabricate hollow-core slabs in which the cavities are substantially higher than the diameter of the feeder auger.

The slanted portions of the core-shaping mandrel according to the invention may be made either asymmetrical relative to the center axis of the feeder auger and the core-shaping mandrel or, alternatively, asymmetrical relative to the center axis, whereby one of the slanted surfaces of the mandrel is longer than the other.

In FIG. 2 is shown the cross section of a conventional hollow-core slab, while FIG. 3 illustrates the cross section of a hollow-core slab manufactured using core-forming mandrels according to the invention. A comparison of the cross sections shown in the diagrams with each other reveals how the core-forming mandrels shaped according to the invention make it possible to make a substantially larger number of cavities in a hollow-core slab of equal height, whereby the number of vertical webs between the hollow-core cavities is larger. Resultingly, the larger number of vertical webs gives the hollow-core slab a higher shear strength. The shapes of the cavities in FIG. 2 also show the essentially smaller width of the cavity in comparison to the height of the cavity.

The core-forming mandrel embodiment according to the invention also permits casting hollow-core slabs of a height greater than that possible in conventional methods.

1. A method for manufacturing a hollow-core concrete product in a substantially horizontal slip-form casting process, in which method concrete mix is fed through a slip-form mold of defined cross section moving progressively in the casting process so as to give a concrete product of a desired shape, wherein the flow of extruded concrete mix is forced to divide into substantially symmetrical subflows in regard to the cross section of the element acting as the core-forming thus facilitating the manufacture of a concrete product having hollow-core cavities of substantially larger cross section than that of the feeder means and essentially smaller width of the hollow-core cavities in comparison to the height of the cavities.

2. An apparatus for manufacturing a controlledly compacted concrete product of the hollow-core type, the apparatus comprising at least one feeder means for feeding concrete mix into a mold of defined cross section and at least one element for forming a hollow-core cavity in said concrete product, the feeder means and the core-forming means being adapted to perform a movement such as to compact the cast concrete mix, and drive means for implementing said movement of said feeder means and said core-forming element, wherein the core-forming element mounted at the trailing end of the feeder means is situated substantially concentrically with the center line of the feeder means and the height of the core-forming element is substantially larger than the maximum diameter of the feeder means and the width of the core-forming element is essentially smaller in comparison to the height of the element.

3. The apparatus of claim 2, wherein the height of the core-forming element at its end connected to the trailing end of the feeder means is substantially equal to the maximum diameter of the feeder means, the height of the core-forming element being adapted to increase over a given length of said element substantially symmetrically in regard to the center line of the feeder means until reaching a height equal to the desired height of the hollow-core cavity to be formed, said given length being substantially shorter than the overall length of said core-forming element.

4. The apparatus of claim 2, wherein the height of the core-forming element at its end connected to the trailing end of the feeder means is substantially equal to the maximum diameter of the feeder means, the height of the core-forming element being adapted to increase over a given length of said element asymmetrically in regard to the center line of the feeder means until reaching a height equal to the desired height of the hollow-core cavity to be formed, said given length being substantially shorter than the overall length of said core-forming element.
